(19) United States
(12) Patent Application Publication
(10) Pub. No.: US 2025/0129928 A1
(43) Pub. Date: Apr. 24, 2025

(54) LIGHTING FIXTURE SEALING RING BASE DEVICE

(71) Applicant: Dongguan Jufeng Lighting Products Co., Ltd., Dongguan (CN)

(72) Inventor: Xing Chen, Dongguan (CN)

(21) Appl. No.: 18/932,208

(22) Filed: Oct. 30, 2024

(30) Foreign Application Priority Data
Sep. 30, 2024 (CN) 202422399367.7

(51) Int. Cl. F21V 31/00; F21V 21/06; F21V 23/00

(52) U.S. Cl. CPC F21V 31/005; F21V 21/06; F21V 23/002

(57) ABSTRACT

A lighting fixture sealing ring base device is provided, relating to the technical field of lighting fixtures. The lighting fixture sealing ring base device includes a supporting assembly and a sealing assembly; the supporting assembly includes a base body, a sealing ring plate, and a bearing seat; the bearing seat is arranged in an upper center of the base body; the sealing ring plate is arranged on a circumferential side of the bearing seat; the sealing assembly includes a sealing ring body and fins; and the sealing ring body abuts against the sealing ring plate.

### TECHNICAL FIELD

The present disclosure relates to the technical field of lighting fixtures, and specifically, to a lighting fixture sealing ring base device.

### BACKGROUND

An existing lamp base is not provided with a sealing ring, so that the base has a poor sealing property. The base is greatly worn during rubbing, and has a poor fixing effect, making it inconvenient to use. Meanwhile, a glass base itself has no place to fix a light source. The light source can be fixed using a sealing ring.

### SUMMARY

### (I) Technical Problems to be Solved

For the shortcomings in the prior art, the present disclosure provides a lighting fixture sealing ring base device.

### (II) Technical Solution

To achieve the above objective, the present disclosure provides the following technical solution: A lighting fixture sealing ring base device includes a supporting assembly and a sealing assembly; the supporting assembly comprises a base body, a sealing ring plate, and a bearing seat; the bearing seat is arranged at an upper center of the base body; the sealing ring plate is arranged on a circumferential side of the bearing seat; the sealing assembly comprises a sealing ring body and fins; the sealing ring body abuts against the sealing ring plate; several groups of the fins are arranged on a circumferential side of the sealing ring body; the sealing ring plate is higher than the bearing seat; a circuit board is arranged on the bearing seat; penetrating wire arrangement chambers are provided on the bearing seat and the base body; several groups of lamp sheets are arranged on the circuit board; the circuit board is further provided with a connecting wire extending into the wire arrangement chambers; and a wire outlet hole is further provided in the base body.

To facilitate assembling of the sealing ring, in an improvement of the present disclosure, a clamping ring is arranged in a center of an outer side of the sealing ring plate, and a clamping slot matched with the clamping ring is provided in the sealing ring body.

Preferably, each of the fins is in an isosceles trapezoid shape.

Preferably, the circuit board is further provided with a fixing rubber strip for fixing the connecting wire.

To ensure the stability of fixing of the base, in an improvement of the present disclosure, an anti-slip pad is further arranged below the base body.

Preferably, the anti-slip pad is glued to the base body.

### (III) Beneficial Effects

Compared with the prior art, the present disclosure discloses a lighting fixture sealing ring base device, which has the following beneficial effects:

According to the lighting fixture sealing ring base device, the bearing seat is arranged at the upper center of the base body and is configured to mount a circuit board; the sealing ring plate is arranged on the circumferential side of the bearing seat to provide a mounting position for the sealing ring body; and the sealing ring body tightly abuts against the sealing ring plate, which can effectively prevent external impurities from entering a lighting fixture. The several groups of fins are arranged on the circumferential side of the sealing ring body, which enlarges a sealing area of the sealing ring and increases a sealing pressure of the sealing ring, and further enhances the sealing effect. Meanwhile, a glass base has no place to fix a light source. The light source can be fixed using the sealing ring.

### BRIEF DESCRIPTION OF THE DRAWINGS

FIG. 1 is a schematic front-view diagram of a structure of the present disclosure;

FIG. 2 is an exploded view of a structure of the present disclosure; and

FIG. 3 is a cross-sectional diagram of assembling of a structure and a lampshade according to the present disclosure.

In the drawings: 1: base body; 2: sealing ring plate; 3: bearing seat; 4: sealing ring body; 5: fin; 6: circuit board; 7: connecting wire; 8: lamp sheet; 9: clamping ring; 10: fixing rubber strip; and 11: anti-slip pad.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

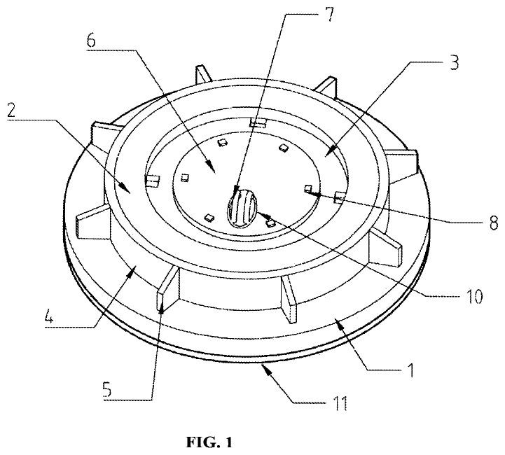

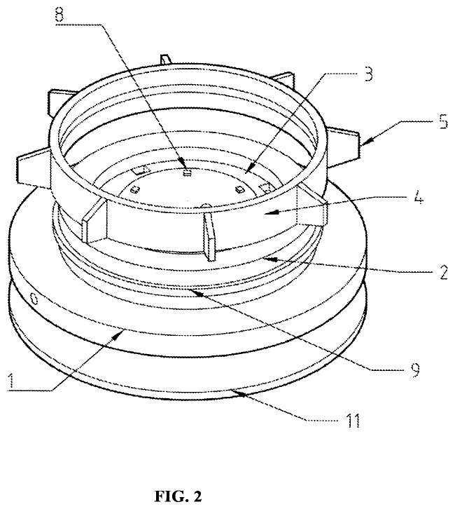

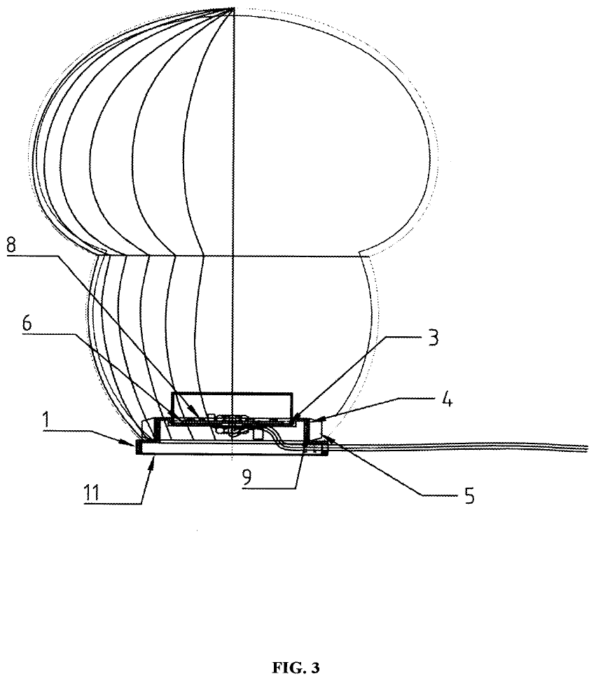

Referring to FIG. 1 to FIG. 3, a lighting fixture sealing ring base device includes a supporting assembly and a sealing assembly. The supporting assembly includes a base body 1, a sealing ring plate 2, and a bearing seat 3; the bearing seat 3 is arranged at an upper center of the base body 1; the sealing ring plate 2 is arranged on a circumferential side of the bearing seat 3; the sealing assembly includes a sealing ring body 4 and fins 5; the scaling ring body 4 abuts against the sealing ring plate 2; several groups of the fins 5 are arranged on a circumferential side of the sealing ring body 4; the sealing ring plate 2 is higher than the bearing seat 3; a circuit board 6 is arranged on the bearing seat 3; penetrating wire arrangement chambers are provided on the bearing seat 3 and the base body 1; several groups of lamp sheets 8 are arranged on the circuit board 6; the circuit board 6 is further provided with a connecting wire 7 extending into the wire arrangement chambers; and a wire outlet hole is further provided in the base body 1.

The base body 1 is used as a basis of the whole device to provide a stable support. The bearing seat 3 at the upper center is configured to place the circuit board 6. The sealing ring plate 2 on the circumferential side of the bearing seat 3 provides a mounting position for the sealing assembly. The sealing ring plate 2 is higher than the bearing seat 3. This design allows the sealing ring body 4 to be mounted on the sealing ring plate 2, so that a protective barrier that is higher than the circuit board 6 can be formed around the circuit board 6. During use of a lighting fixture, if there are external impurities such as dust and moisture approaching, the sealing ring can prevent these impurities from entering the region of the circuit board 6 on the bearing seat 3. The sealing ring body 4 achieves a sealing function by tightly abutting against the sealing ring plate 2. When the sealing ring body 4 is mounted on the sealing ring plate 2, a clamping slot on the sealing ring body 4 and a clamping ring 9 in a center of an outer side of the sealing ring plate 2 cooperate with each other to ensure that the sealing ring body 4 will not easily move during use. The design of the clamping ring 9 and the clamping slot facilitates the assembling of the sealing ring. During mounting, the clamping slot on the sealing ring body 4 only needs to be aligned with the clamping ring 9 and pressed to quickly complete the mounting of the sealing ring. After the sealing ring is mounted, the several groups of fins 5 on the circumferential side of the sealing ring body 4 will be in contact with a surface of the mounting position, which enlarges a sealing area and increases a sealing pressure. Due to the isosceles-trapezoid-shaped fins 5, under an external pressure, the fins 5 will deform to an extent to better adapt to different mounting surfaces, which further enhances the sealing effect. The lamp sheets 8 on the circuit board 6 emit light after being powered on, thereby achieving a lighting function of the lighting fixture. A connecting wire 7 on the circuit board 6 extends into penetrating wire arrangement chambers of the bearing seat 3 and the base body 1, is finally led out from a wire outlet hole on the base body 1, and is connected to an external power supply or control equipment.

In actual use, the circuit board 6 is further provided with a fixing rubber strip 10 for fixing the connecting wire 7. The fixing rubber strip 10 is configured to fix the connecting wire 7 to prevent the connecting wire 7 from being loosened or moving during use of the lighting fixture. After the connecting wire 7 is mounted on the circuit board 6, the fixing rubber strip 10 is adhered around the connecting wire 7 to tightly abut against the circuit board 6, thereby fixing the connecting wire 7.

In this embodiment, an anti-slip pad 11 is further arranged below the base body 1. The anti-slip pad 11 is glued to the base body 1 to ensure the stability of fixing of the base body 1.

To provide a detailed explanation of possible application scenarios, technical principles, feasible specific solutions, and objectives and effects that can be achieved of the present disclosure, the following specific embodiments will be described in detail in conjunction with the accompanying drawings. The embodiments herein are only configured to more clearly illustrate the technical solutions of the present disclosure, and therefore are only used as examples and cannot be configured to limit the scope of protection of the present disclosure.

Reference to “an embodiment” herein means that a particular feature, structure or characteristic described in conjunction with an embodiment may be included in at least one embodiment of this application. The term “embodiment” appearing in various positions in this specification does not necessarily mean the same embodiment, and does not specifically limit its independence or association with other embodiments. In principle, in the present disclosure, as long as there are no technical contradictions or conflicts, the various technical features mentioned in the various embodiments can be combined in any way to form corresponding feasible technical solutions.

Unless otherwise defined, the meanings of the technical terms used herein are the same as those commonly understood by those skilled in the art to which the present disclosure belongs. The use of the relevant terms herein is only for the purpose of describing the specific embodiments, and is not intended to limit the scope of the present disclosure.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A lighting fixture sealing ring base device, comprising a supporting assembly and a sealing assembly, wherein the supporting assembly comprises a base body (1), a sealing ring plate (2), and a bearing seat (3); the bearing seat (3) is arranged at an upper center of the base body (1); the sealing ring plate (2) is arranged on a circumferential side of the bearing seat (3);
the sealing assembly comprises a sealing ring body (4) and fins (5); the sealing ring body (4) abuts against the sealing ring plate (2); several groups of the fins (5) are arranged on a circumferential side of the sealing ring body (4); the sealing ring plate (2) is higher than the bearing seat (3); a circuit board (6) is arranged on the bearing seat (3); penetrating wire arrangement chambers are provided on the bearing seat (3) and the base body (1); several groups of lamp sheets (8) are arranged on the circuit board (6); the circuit board (6) is further provided with a connecting wire (7) extending into the wire arrangement chambers; and a wire outlet hole is further provided in the base body (1).

2. The lighting fixture sealing ring base device according to claim 1, wherein a clamping ring (9) is arranged in a center of an outer side of the sealing ring plate (2), and a clamping slot matched with the clamping ring (9) is provided in the sealing ring body (4).

3. The lighting fixture sealing ring base device according to claim 2, wherein each of the fins (5) is in an isosceles trapezoid shape.

4. The lighting fixture sealing ring base device according to claim 3, wherein the circuit board (6) is further provided with a fixing rubber strip (10) for fixing the connecting wire (7).

5. The lighting fixture sealing ring base device according to claim 4, wherein an anti-slip pad (11) is further arranged below the base body (1).

6. The lighting fixture sealing ring base device according to claim 5, wherein the anti-slip pad (11) is glued to the base body (1).
